(19) United States
(12) Patent Application Publication
(10) Pub. No.: US 2003/0172164 A1
(43) Pub. Date: Sep. 11, 2003

(54) server persistence using a session identifier

(76) Inventor: Chesley B. Coughlin, San Diego, CA (US)

Correspondence Address: KENYON & KENYON, 1500 K STREET, N.W., SUITE 700, WASHINGTON, DC, 20005, US

(21) Appl. No.: 10/096,135

(22) Filed: Mar. 11, 2002

(51) Int. Cl. G06F 15/173

(52) U.S. Cl. 709/227; 709/238; 709/105

(57) ABSTRACT

A method of accessing data from a plurality of servers includes receiving a request for the data, the request including a first transport protocol independent message. The method further includes sending the request to a first server of the plurality of servers and receiving the data from the first server through a session, the data including a second transport protocol independent message. The method further includes adding a first session identifier that corresponds to the session to the second transport protocol independent message.

### FIELD OF THE INVENTION

The present invention is directed to data access to a remote server. More particularly, the present invention is directed to maintaining persistence to a single remote server that is accessed using any transport protocol.

### BACKGROUND INFORMATION

In order to provide responsiveness and availability to customers, many e-commerce sites on the Internet employ multiple servers and a load balancer. In essence, the load balancer makes the multiple servers look like a single, high-powered network resource to those accessing the site. It does this by selectively forwarding connections to the many servers arrayed behind it in an equitable manner, according to the server's operational health and the nature of the query.

A problem exists because individual users must be tied to a single server and maintain persistence to that server for secure transactions and for enhancing the experience for the user. For example, navigating an online application, such as a shopping cart or stock trading system, requires a series of interactions between the visitor and the site's back-end applications. These applications need to know where a user was, so that they can decide where the user will be next. If a load balancer or other device redirects the user to a different web server during an interaction session, this may cause the connection to fail, and the user's session will be ended prematurely. In addition, the user's previously entered information, such as the contents of a shopping cart, may be lost.

Initially, an Internet Protocol (“IP”) address was used to correlate an individual user session. However, as the Internet grew, IP addresses were no longer tied to an individual user or single machine. Instead, Internet Service Providers (“ISP”s) such as America Online (“AOL”) proxied user connections through a few IP addresses. This is now common practice at most corporations and ISPs. This problem is commonly referred to as the “mega proxy problem”.

Web sites need some means to associate a user with a specific server. Many applications and web sites will simply not work without persistence. A likely result of the lack of persistence is that the user will leave the site unsatisfied and may never return.

One way to overcome the mega proxy problem is for the user to accept cookies on the user's machine. The cookies allow the user to be directed to the correct server and maintain persistence to the server.

Another solution to the mega proxy problem is referred to as “URL munging”. In Uniform Resource Locator (“URL”) munging, a session identifier is stored as part of the URL. Server software uses the session identifier to identify that user's session. However, URL munging requires the web links on each web page to be updated at runtime to uniquely identify the current session. This is a CPU intensive operation, which limits the servers capacity.

Most client/server interactions described above are deployed over HyperText Transport Protocol (“HTTP”) or secure HTTP (“HTTPS”). The cookie and URL munging solutions to the persistence problem only work with HTTP or HTTPS protocol. However, future client/server interactions may run over non-HTTP protocols, such as Transmission Control Protocol (“TCP”), Simple Mail Transport Protocol (“SMTP”), etc.

Based on the foregoing, there is a need for a method for maintaining persistence with a server while using a load balancer that functions with non-HTTP protocols.

### BRIEF DESCRIPTION OF THE DRAWINGS

FIG. 1 is a block diagram of a system in accordance with one embodiment of the present invention.

FIG. 2 is a flow diagram of the functions performed by a load balancer and other devices of the system in accordance with one embodiment of the present invention.

### DETAILED DESCRIPTION

One embodiment of the present invention is a system that adds a session identifier (“Session ID”) to the header of a transport protocol independent message. A load balancer directs all subsequent requests from a user that includes the Session ID to a server identified by the Session ID.

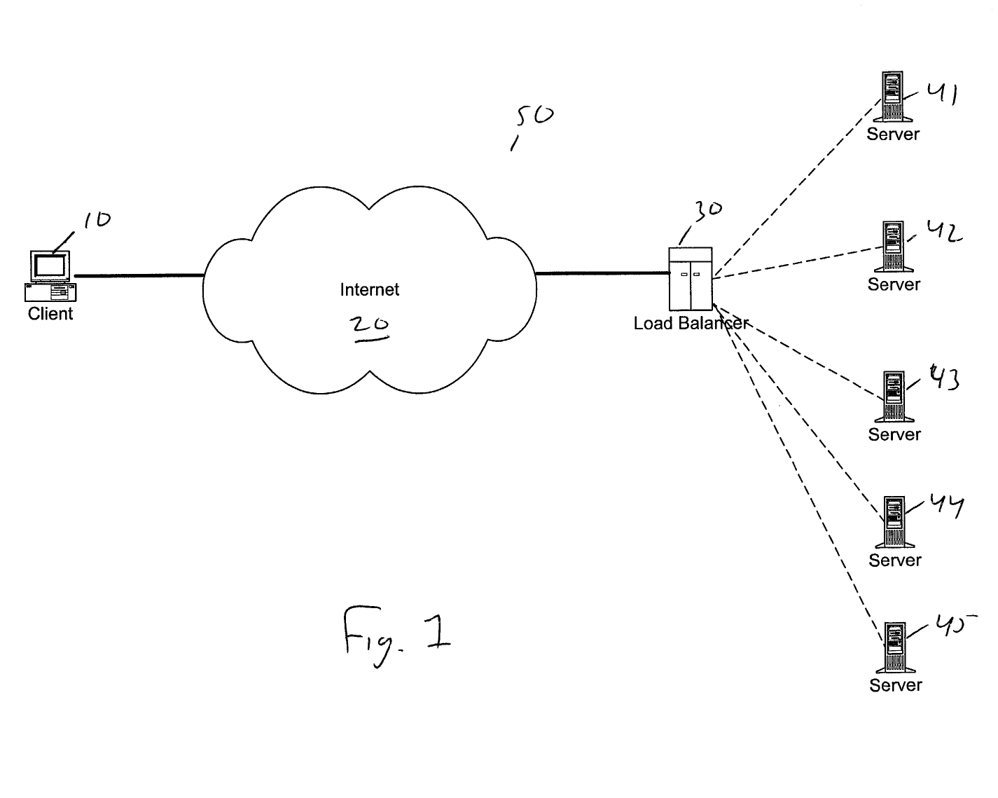

FIG. 1 is a block diagram of a system 50 in accordance with one embodiment of the present invention. System 50 includes the Internet 20 and a client computer 10 that is used to access Internet 20. Client computer 10 can be any known personal computer or other device that includes a network application such as an Internet Web browser. The network application can be the Internet Explorer from Microsoft Corp., or any other type of application that communicates with other applications via a network. Client computer 10 accesses Internet 20 through known methods such as through an Internet service provider (not shown).

System 50 further includes a load balancer 30 coupled to servers 41-45. Servers 41-45 form a group of servers that provide the same or similar content to a user and can each respond to the same URL request or other type of request from a client. Load balancer 30 can be any known load balancer that is modified to implement the present invention. In one embodiment, load balancer 30 is the NetStructure 7180 e-commerce Director from Intel Corp. that has been modified to perform the functions described below. Load balancer 30 includes a processor and a memory or other type of computer readable medium.

In one embodiment, client 10 accesses load balancer 30 and servers 41-45 via Internet 20 through the transmission and receipt of Simple Object Access Protocol (“SOAP”) messages. SOAP is a lightweight protocol for exchange of information in a decentralized, distributed environment. It is an Extensible Markup Language (“XML”) based protocol that consists of four parts: an envelope that defines a framework for describing what is in a message and how to process it, a transport binding framework for exchanging messages using an underlying protocol, a set of encoding rules for expressing instances of application-defined data types and a convention for representing remote procedure calls and responses. SOAP Version 1.1 is disclosed in a World Wide Web Consortium (“W3C”) note published on May 8, 2000, and available at www.w3.org/TR/SOAP.

A SOAP message is an XML document that consists of a mandatory SOAP envelope, an optional SOAP header, and a mandatory SOAP body. Although the described embodiments of the present invention utilize SOAP messages, any known or future transport protocol independent messages having a header may be used instead of SOAP messages.

In one embodiment, client 10 accesses load balancer 30 and servers 41-45 via Internet 20 over HTTP protocol. However, in other embodiments the access is over any other known or future protocol, including TCP, SMTP, File Transfer Protocol (“FTP”), etc. The present invention can operate in a transport protocol neutral environment through the use of transport protocol independent messages having a header such as SOAP messages.

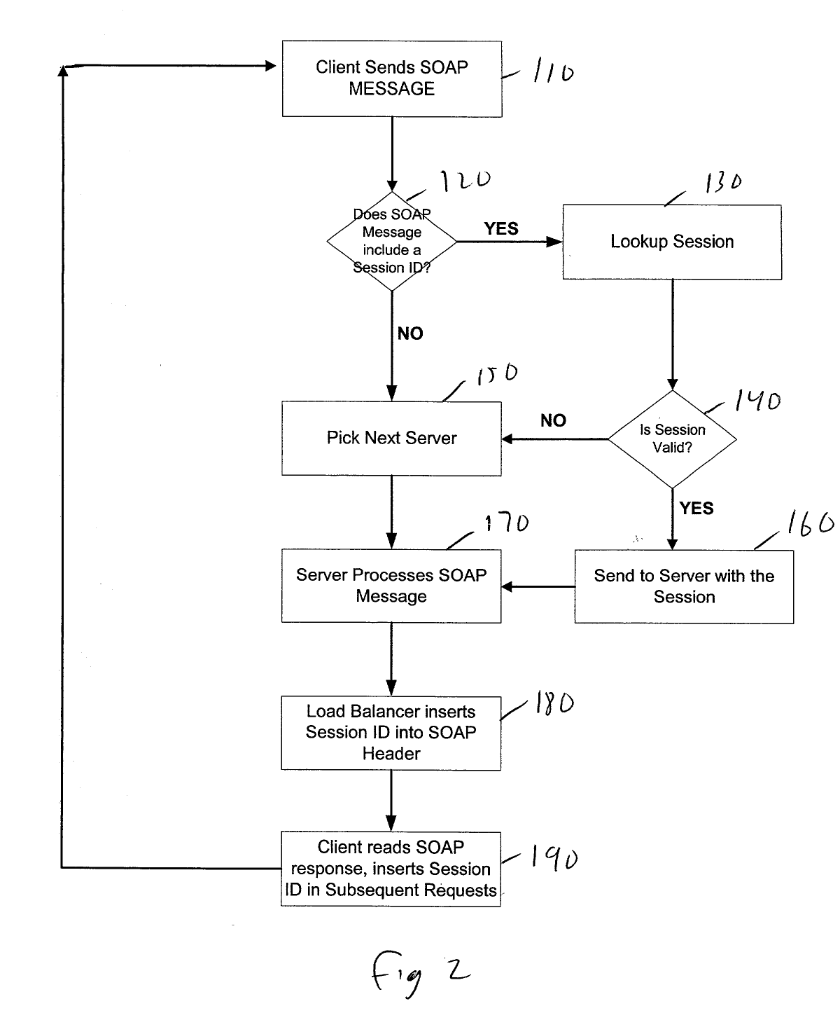

FIG. 2 is a flow diagram of the functions performed by load balancer 30 and other devices of system 50 in accordance with one embodiment of the present invention. In one embodiment, the functions are implemented by software stored in memory and executed by the processor of load balancer 30. In other embodiments, the functions can be performed by hardware, or any combination of hardware and software. The functions can also be performed by a device that is separate from, but in communication with, load balancer 30.

At box 110, load balancer 30 receives a SOAP message from client computer 10. The SOAP message includes a request and is directed to a server or to a web site that is concurrently located on each of servers 41-45. The SOAP message may be sent via HTTP, SMTP, TCP, or any other transport protocol. The SOAP message includes a header.

At decision point 120, load balancer 30 determines if the header of the SOAP message includes a Session ID that identifies a session on one of servers 41-45. If the SOAP message header does not include a Session ID, then the SOAP message represents a new request and at box 150 load balancer 30 forwards the request to one of servers 41-45 based on the configured load balancing algorithm. Load balancing algorithms typically distribute requests or queries equitably among servers 41-45 in order to amortize load and improve availability by avoiding downed servers.

If the SOAP message header includes a Session ID at decision point 120, at box 130 load balancer 30 looks up the Session ID within the header. The session indicated by the Session ID is then validated at decision point 140. In one embodiment, load balancer 30 validates the session by checking its internal server to the Session ID mapping table. If the session is valid, then at box 160 the SOAP message is sent directly to the server among servers 41-45 that has the session. If the session is not valid (e.g., either expired or no longer in the server to Session ID mapping table), the server is picked based on the configured load balancing algorithm at box 150.

At box 170, the server among servers 41-45 that received the SOAP message processes the SOAP message. As a result, the server will return a response SOAP message to load balancer 30.

At box 180, load balancer 30 inserts a Session ID into the SOAP message returned from the server. The Session ID corresponds to the session that generated the returned SOAP message.

Finally, at box 190 the revised response SOAP message is sent to client computer 10. Client computer 10 reads the SOAP message and inserts the Session ID included in the header on subsequent requests. Therefore, subsequent requests from client computer 10 at box 110 will now include a Session ID.

As described, the present invention sends all requests from client computer 10 to the same server once a connection to that server has been set up. The association is maintained even if the connection is broken or closed by client computer 10 or the server during a session. Therefore, for example, if during a session a user is placing items in a shopping cart, the current status of the shopping cart will be maintained throughout the session.

The present invention provides an advantage over cookies and URL munging because it is not HTTP dependent. This allows the present invention to utilize both non-HTTP and HTTP protocols in load balanced web service environments.

Several embodiments of the present invention are specifically illustrated and/or described herein. However, it will be appreciated that modifications and variations of the present invention are covered by the above teachings and within the purview of the appended claims without departing from the spirit and intended scope of the invention.

For example, in the embodiments described, the Session ID is generated by the load balancer. However, in other embodiments Session ID may be generated at the client computer and can be inserted into the transport protocol independent message header at either the client computer or the server. In these embodiments, the client and the server generate a Globally Unique ID (“GUID”).

What is claimed is:

1. A method of accessing data from a plurality of servers comprising:
receiving a request for the data, the request comprising a first transport protocol independent message;
sending the request to a first server of the plurality of servers;
receiving the data from the first server through a session, the data comprising a second transport protocol independent message; and
adding a first session identifier that corresponds to the session to the second transport protocol independent message.

2. The method of claim 1, wherein the first transport protocol independent message and the second transport protocol independent message are Simple Object Access Protocol (SOAP) messages.

3. The method of claim 1, further comprising:
determining whether the request includes a second session identifier.

4. The method of claim 1, wherein the sending the request to the first server comprises a load balancing algorithm.

5. The method of claim 3, wherein the sending the request to the first server comprises sending the request to a server corresponding to the second session identifier.

6. The method of claim 1, wherein the request is received over an Internet.

7. The method of claim 1, wherein the first transport protocol independent message and the second transport protocol independent message are Extensible Markup Language (XML) documents.

8. The method of claim 1, further comprising:
inserting the second session identifier in requests generated at the client computer.

9. A load balancer comprising:
a processor; and
memory coupled to said processor;
wherein the memory stores instructions which, when executed by said processor, cause said processor to:
send a request for data, the request comprising a first transport protocol independent message, to a first server of a plurality of servers;
receive the data from the first server through a session, the data included in a second transport protocol independent message; and
add a first session identifier that corresponds to the session to the second transport protocol independent message.

10. The load balancer of claim 9, wherein the first transport protocol independent message and the second transport protocol independent message are Simple Object Access Protocol (SOAP) messages.

11. The load balancer of claim 9, said processor further caused to:
determine whether the request includes a second session identifier.

12. The load balancer of claim 9, wherein the processor sends the request to the first server by executing a load balancing algorithm.

13. The load balancer of claim 11, wherein the processor sends the request to the first server by sending the request to a server corresponding to the second session identifier.

14. The load balancer of claim 9, wherein the first transport protocol independent message and the second transport protocol independent message are Extensible Markup Language (XML) documents.

15. A computer readable medium having instructions stored thereon that, when executed by a processor, cause the processor, after receiving a request for data from a client computer, to:
send the request to a first server of a plurality of servers, the request comprising a first transport protocol independent message;
receive the data from the first server through a session, the data comprising a second transport protocol independent message; and
add a first session identifier that corresponds to the session to the second transport protocol independent message.

16. The computer readable medium of claim 15, wherein the first transport protocol independent message and the second transport protocol independent message are Simple Object Access Protocol (SOAP) messages.

17. The computer readable medium of claim 15, said instructions further cause said processor to:
determine whether the request includes a second session identifier.

18. The computer readable medium of claim 15, wherein the processor sends the request to the first server by executing a load balancing algorithm.

19. The computer readable medium of claim 15, wherein the processor sends the request to the first server by sending the request to a server corresponding to the second session identifier.

20. The computer readable medium of claim 15, wherein the first transport protocol independent message and the second transport protocol independent message are Extensible Markup Language (XML) documents.
